(19) United States
(12) Patent Application Publication
(10) Pub. No.: US 2007/0153299 A1
(43) Pub. Date: Jul. 5, 2007

(54) PRE-SCANNING DEVICE AND PRE-SCANNING METHOD USING THE SAME

(75) Inventors: Kui Lv, Jiangsu Province (CN); Xin-Yang Zhu, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/616,958

(22) Filed: Dec. 28, 2006

(30) Foreign Application Priority Data
Jan. 5, 2006 (TW) 95100515

(51) Int. Cl. G06F 3/12

(52) U.S. Cl. 358/1.1

(57) ABSTRACT

A pre-scanning device and a pre-scanning method thereof are provided. The pre-scanning device is provided for pre-scanning an article. The pre-scanning device includes a scanning module, a user interface and a driver unit. The user interface has a dynamical setting unit for a user to set a pre-scanning range. The driver unit is used for driving the scanning module to pre-scan the article within the pre-scanning range. The pre-scanning method is provided for pre-scanning an article. Firstly, a dynamic setting mode is entered. Next, a pre-scanning range is set. Thereafter, the article within the pre-scanning range is pre-scanned.

This application claims the benefit of Taiwan application Serial No. 095100515, filed Jan. 5, 2006, the subject matter of which is incorporated herein by reference.

### BACKGROUND OF THE INVENTION

1. Field of the Invention

The invention relates in general to a pre-scanning device and a pre-scanning method thereof, and more particularly to a pre-scanning device capable of adjusting the pre-scanning range and a pre-scanning method thereof.

2. Description of the Related Art

Along with the advance in image scanning technology, the application of scanner becomes wider and wider. The scanner retrieves and converts an image into digital image data to be stored in a computer. The digital image data does not need physical space, can be saved permanently, and the color does not fade out. Moreover, the computer can further modify, enlarge/reduce, print, and apply color-adjustment or special effect to the color image of digital image data. The image scanning technology makes image processing more flexible and versatile, and further enriches people's life.

Normally, when a book or a non-standard sized article is scanned, the article is not placed at a fixed position on the scan platform. Therefore, the scanner normally has a pre-scanning device for scanning a pre-scanning image. The user can determine a range for retrieving and storing an image according to the pre-scanning image.

Referring to FIG. 1, a pre-scanning process of a conventional pre-scanning device is shown. The conventional pre-scanning device 100 has a pre-scanning range 500. No matter what size the target article is, the range and size of the pre-scanning range 500, such as an A4 size of 21 cm×29.7 cm, are fixed. The pre-scanning range 500 has a fixed scanning starting position SP1 and a fixed scanning ending position EP1. When the conventional pre-scanning device 100 receives a pre-scan instruction, firstly, the scanning module 200 is moved from the scanning starting position SP1 along a direction S21. While the scanning module 200 is moved along the direction S21, the scanning module 200 continues scanning the article until the scanning module 200 reaches the scanning ending position EP1. Then, the scanning module 200 is halted and stops scanning the article. Next, the scanning module 200 returns to the scanning starting position SP1 along a direction S22.

When the pre-scanning device 100 receives another pre-scan instruction, the scanning module 200 pre-scans according to the same pre-scanning range 500. The scanning module 200 pre-scans the article again along the direction S21 and returns along the direction S22.

No matter what size the target article is, the range and size of the conventional pre-scanning range 500 are fixed. If the actual range 900 of the target article, such as a B5 size of 17.6 cm×25 cm, is smaller than the conventional pre-scanning range 500, the pre-scanning range 500 is obviously over the actual range 900 of the target article. The conventional scanning device 100 will waste too much time scanning an inappropriate pre-scanning range.

Moreover, no matter where the actual range 900 of the target article is positioned, the conventional scanning module 200 is unable to perform next pre-scanning without returning to the fixed scanning starting position SP1 first along the direction S22. Thus, the conventional scanning device 100 will waste too much time in moving the scanning module 200.

### SUMMARY OF THE INVENTION

It is therefore an object of the invention to provide a pre-scanning device and a pre-scanning method thereof. The invention provides a user interface capable of setting a pre-scanning range and a pre-scanning method thereof and enables scanning to be performed from the nearest scanning starting position, not only scanning the target range precisely but also saving pre-scanning time.

The invention achieves the above-identified object by providing a pre-scanning device for pre-scanning an article. The pre-scanning device includes a scanning module, a user interface and a driver unit. The user interface has a dynamical setting unit for a user to set a pre-scanning range according to the article. The driver unit is used for driving the scanning module to pre-scan the article within the pre-scanning range.

The invention achieves another object by providing a pre-scanning method for pre-scanning an article. Firstly, a dynamic setting mode is entered. Next, a pre-scanning range is set according to the article. Thereafter, the article is pre-scanned within the pre-scanning range.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a pre-scanning process of a conventional pre-scanning device;

FIG. 2 is a diagram of a pre-scanning device according to the invention;

FIG. 3 is a flowchart of a pre- scanning method according to the invention;

FIG. 4 is a diagram of a dynamical setting unit of the pre-scanning device according to a first embodiment of the invention;

FIG. 5 is a step flowchart of setting a pre-scanning range according to the first embodiment of the invention;

FIG. 6 shows a state of the pre-scanning process when the scanning module is closer to a first side;

FIG. 7 shows a state of the pre-scanning process when the scanning module is closer to a second side;

FIG. 8 shows a state of the pre-scanning process when the scanning module is moved to a scanning homing position and performs pre-scanning again;

FIG. 9 is a diagram of a dynamical setting unit according to a second embodiment of the invention;

FIG. 10 is a step flowchart of setting a pre-scanning range according to the second embodiment of the invention;

FIG. 11 is a diagram of a dynamical setting unit according to a third embodiment of the invention; and

FIG. 12 is a step flowchart of setting a pre-scanning range according to the third embodiment of the invention.

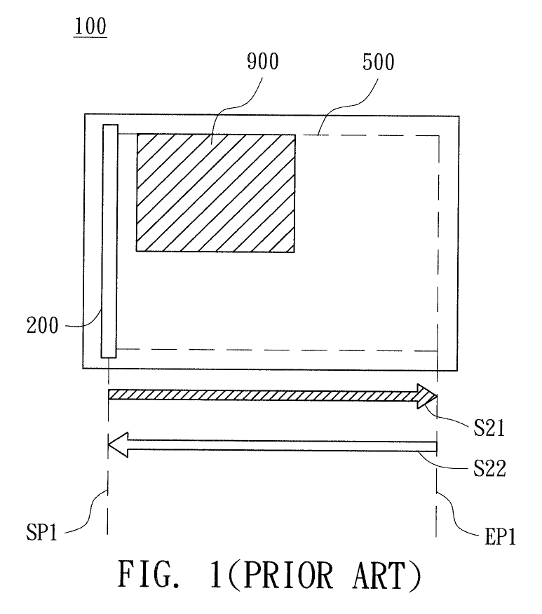

### DETAILED DESCRIPTION OF THE INVENTION

### First Embodiment

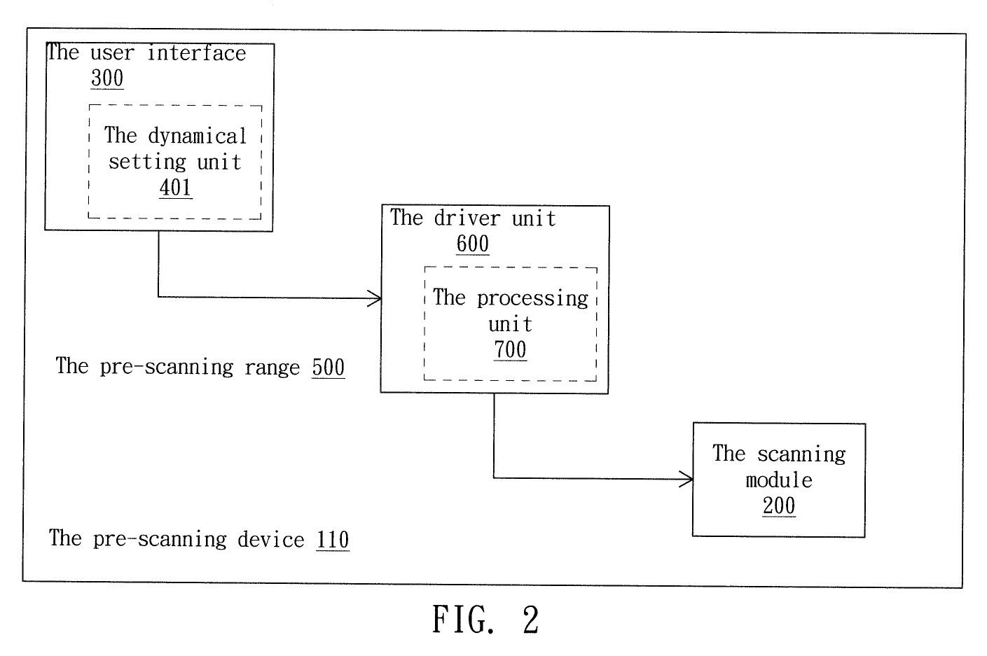

Referring to FIG. 2, a diagram of a pre-scanning device according to the invention is shown. The pre-scanning device 110 is provided for pre-scanning an article. The pre-scanning device 110 includes a scanning module 200, a user interface 300 and a driver unit 600. The user interface 300 has a dynamical setting unit 401 for a user to set a pre-scanning range 500 according to an article. The driver unit 600 is used for driving the scanning module 200, such that the scanning module 200 pre-scans an article within the pre-scanning range 500.

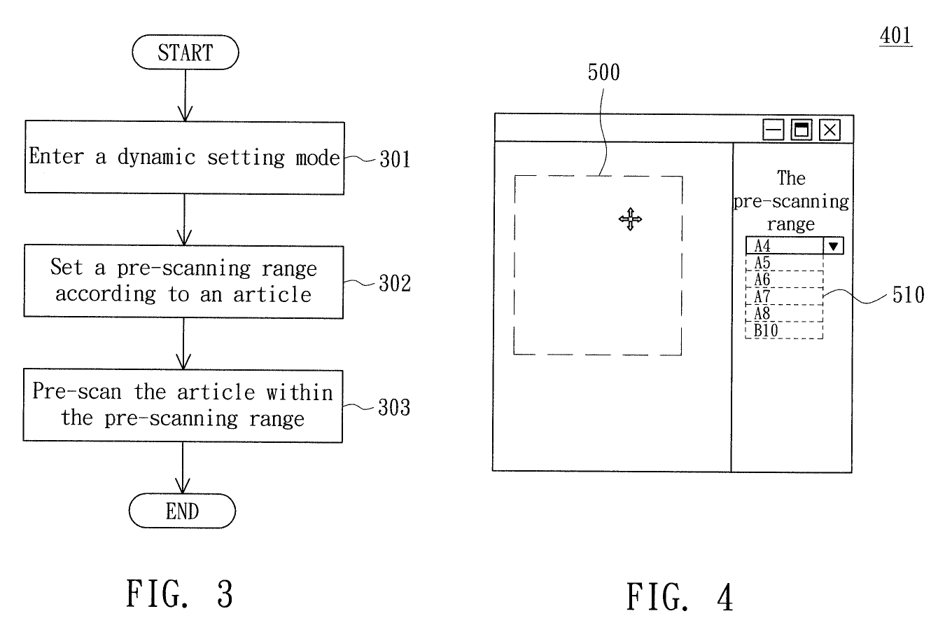

Referring to FIG. 3, a flowchart of a pre- scanning method according to the invention is shown. Firstly, the pre-scanning method begins at step 301, a dynamic setting mode is entered via a user interface 300. The dynamic setting mode is created in the dynamical setting unit 401. Next, the user sets a pre-scanning range 500 in the dynamical setting unit 401 according to the size and position of the article as indicated in step 302. Then, the scanning module 200 pre-scans the article within the pre-scanning range 500 as indicated in step 303. Lastly, the pre-scanning method of the invention is terminated.

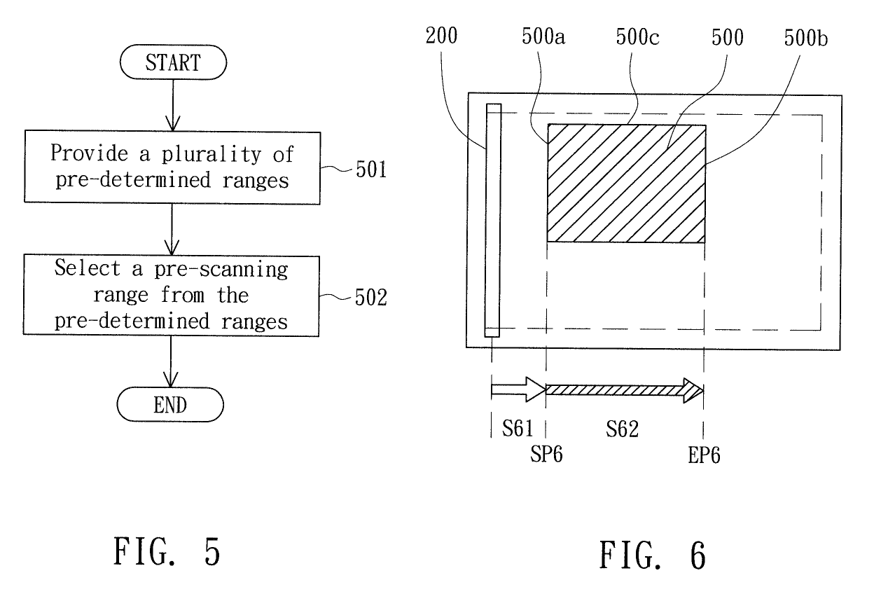

Referring to both FIG. 4 and FIG. 5. FIG. 4 is a diagram of a dynamical setting unit of the pre-scanning device according to a first embodiment of the invention. FIG. 5 is a step flowchart of setting a pre-scanning range according to the first embodiment of the invention. In FIG. 4, the dynamical setting unit 401 has at least a parameter, and the user sets a corresponding value of the at least one parameter to define the pre-scanning range 500. As indicated in FIG. 5, the step of setting pre-scanning range in the first embodiment further includes the following sub-steps. Firstly, a plurality of pre-determined ranges 510 such as A4, A5, B5, A6 or B10, are provided in the dynamical setting unit 401 of the user interface 300 as indicated in step 501. Next, the user selects a pre-scanning range 500 according to the pre-determined range 510 as indicated in step 502.

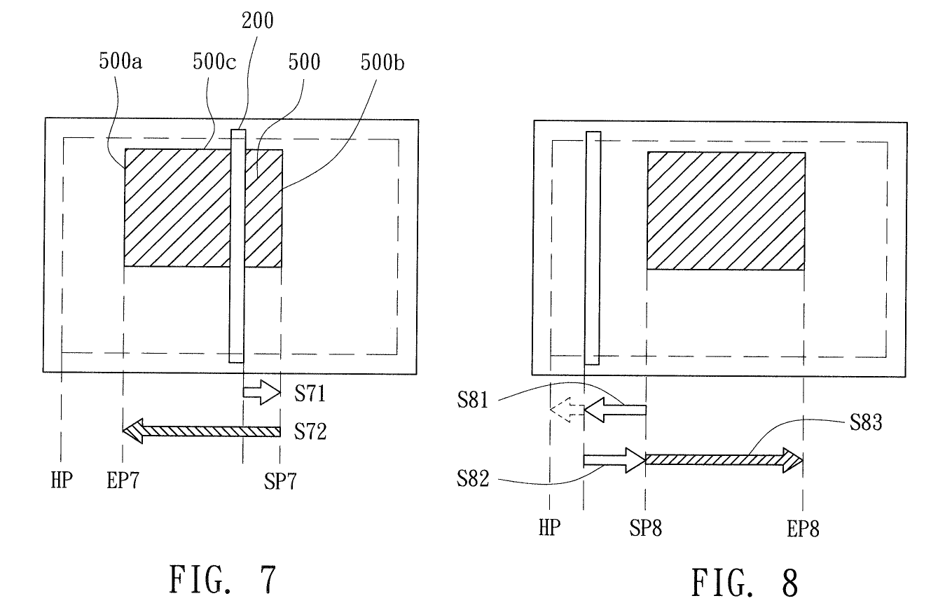

Referring to FIG. 2, FIG. 6, FIG. 7 and FIG. 8 at the same time. FIG. 6 shows a state of the pre-scanning process when the scanning module is closer to a first side. FIG. 7 shows a state of the pre-scanning process when the scanning module is closer to a second side. FIG. 8 is a state of the pre-scanning process when the scanning module is moved to a scanning homing position and performs pre-scanning again.

As indicated in FIG. 6, FIG. 7 and FIG. 8, the pre-scanning range 500 is exemplified by a rectangle in the present embodiment of the invention. However, the technology of the invention is not limited thereto. The pre-scanning range is not limited to any shapes, and the pre-scanning range of any shape is still within the scope of technology of the invention. The pre-scanning range 500 has a first side 500a and a second side 500b opposite to the first side 500a, and a third side 500c vertically connecting the first side 500a and the second side 500b. The scanning module 200 reciprocates along a direction parallel to the third side 300c.

The pre-scanning device 110 further includes a processing unit 700 for determining and setting the first side 500a or the second side 500b to be a scanning starting position nearest to the scanning module 200, such that the scanning module 200 is able to perform next pre-scanning process without returning to the scanning homing position HP first.

As indicated in FIG. 6, when the scanning module 200 is closer to the first side 500a, the processing unit 700 sets the first side 500a to the nearest scanning starting position SP6, and the driver unit 600 moves the scanning module 200 to the nearest scanning starting position SP6 along a direction S61. Next, the driver unit 600 drives the scanning module 200 along a direction S62 heading towards a scanning ending position EP6 to pre-scan the article within the pre-scanning range 500.

As indicated in FIG. 7, when the scanning module 200 is closer to the second side 500b, the processing unit 700 sets the second side 500b to be the nearest scanning starting position SP7, and the driver unit 600 drives the scanning module 200 towards the nearest scanning starting position SP7 along a direction S71. Next, the driver unit 600 drives the scanning module 200 to pre-scan the article within the pre-scanning range 500 along a direction S72 heading towards the scanning ending position EP7. After obtaining the pre-scanning image of the article, due to the pre-scanning module 200 scans the article towards the scanning homing position HP, the processing unit 700 reverses the retrieved image by 180 degrees.

Referring to FIG. 8, a state of the pre-scanning process when the scanning module is moved to a scanning homing position and performs pre-scanning again is shown. After the scanning module 200 completes a pre-scanning process, the scanning module 200 can be halted at a scanning ending position EP8 or moved to a scanning homing position HP by the driver unit 600. As indicated in FIG. 8, if a scan instruction is received again during the process of moving the scanning module 200 to the scanning homing position HP along a direction S81, then the processing unit 700 re-determines and sets the first side 500a or the second side 500b to be an another scanning starting position SP8 nearest to the scanning module 200, and the driver unit 600 drives the scanning module 200 to the new nearest scanning starting position SP8 along a direction S82. Next, the driver unit 600 drives the scanning module 200 to pre-scan an article within the pre-scanning range 500 along a direction S83 heading towards the scanning ending position EP8.

### Second Embodiment

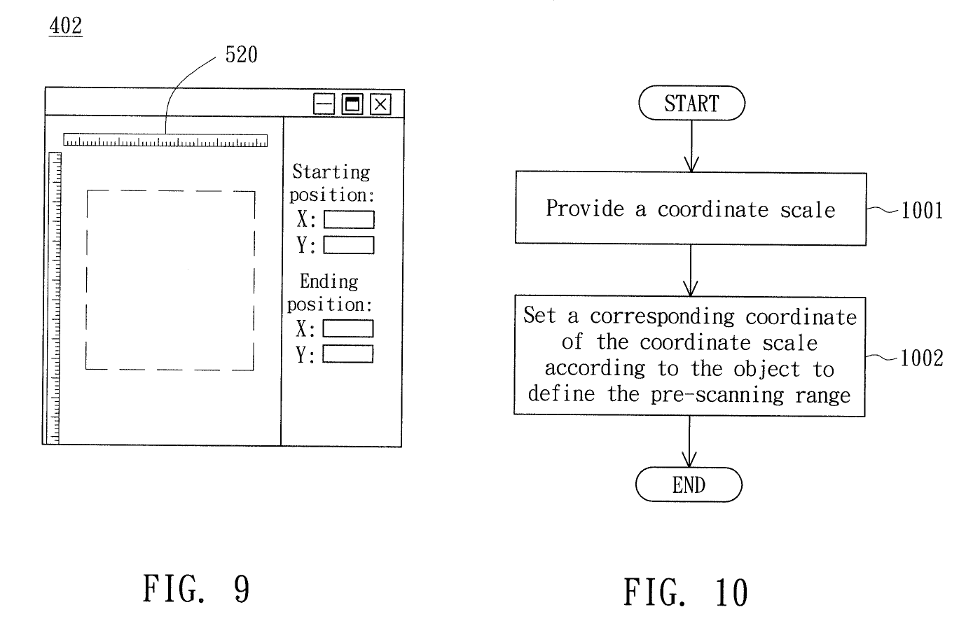

The pre-scanning device of the present embodiment of the invention differs with the pre-scanning device of the first embodiment in the step of setting the pre-scanning range and the dynamical setting unit 402. As for other similarities, the same reference numbers are used and are not repeated here. Referring to both FIG. 9 and FIG. 10. FIG. 9 is a diagram of a dynamical setting unit according to a second embodiment of the invention. FIG. 10 is a step flowchart of setting a pre-scanning range according to the second embodiment of the invention. In FIG. 9, the dynamical setting unit 402 has a coordinate scale 520. As indicated in FIG. 10, the step of setting the pre-scanning range according to the second embodiment includes the following sub-steps. Firstly, a coordinate scale 520 is provided by the dynamical setting unit 402 of the user interface 300 as indicated in step 1001. Next, the user sets a corresponding coordinate of the coordinate scale 520 according to the article to define a pre-scanning range 500 as indicated in step 1002.

### Third Embodiment

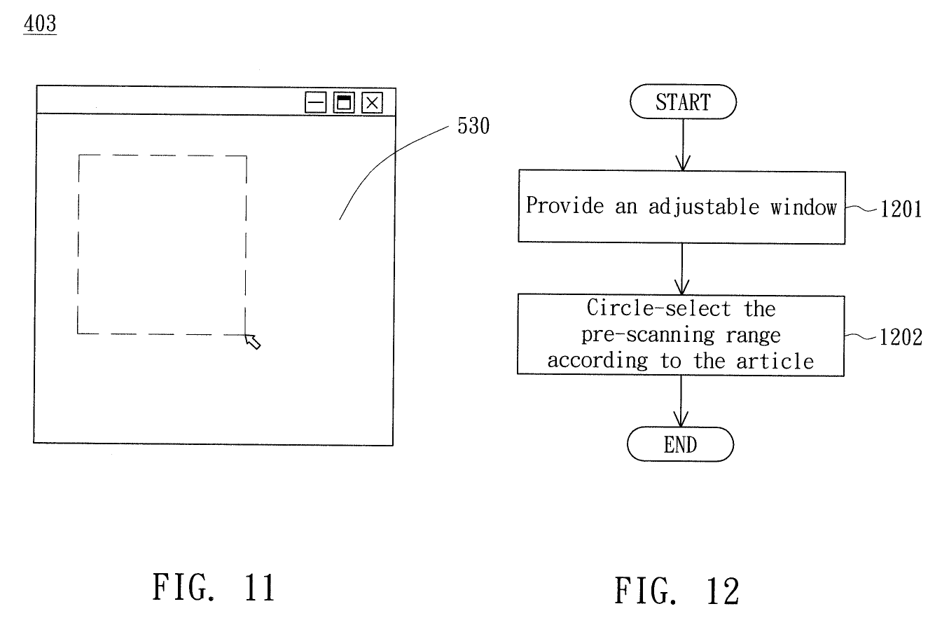

The pre-scanning device of the present embodiment of the invention differs with the pre-scanning device of the first embodiment in the step of setting the pre-scanning range and the dynamical setting unit 403. As for other similarities, the same reference numbers are used and are not repeated here. Referring to both FIG. 11 and FIG. 12. FIG. 11 is a diagram of a dynamical setting unit according to a third embodiment of the invention. FIG. 12 is a step flowchart of setting a pre-scanning range according to the third embodiment of the invention. In FIG. 11, the dynamical setting unit 403 has an adjustable window 530. As indicated in FIG. 12, the step of setting the pre-scanning range according to the third embodiment includes the following sub-steps. Firstly, an adjustable window 530 is provided by the dynamical setting unit 403 of the user interface 300 as indicated in step 1201. Next, the pre-scanning range 500 is selected by the user according to the article as indicated in step 1202.

As disclosed in the above three embodiments, the step of setting the pre-scanning range is exemplified by providing a plurality of pre-determined ranges, a coordinate scale or an adjustable window. However, the pre-scanning range can be set by a user interface in various ways. Any kind of ways to set the pre-scanning range is within the scope of technology of the invention. For example, in the pre-scanning step of the invention, the shape of the pre-scanning range can be a circular range or a irregular range.

A pre-scanning device and a pre-scanning method thereof are disclosed in the above embodiments of the invention. The invention provides a user interface capable of setting a pre-scanning range and a pre-scanning method thereof and enables scanning to be performed from the nearest scanning starting position, not only scanning the target range precisely but also saving pre-scanning time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pre-scanning device for pre-scanning an article, the device comprising:
a scanning module;
a user interface having a dynamical setting unit for setting a pre-scanning range; and
a driver unit for driving the scanning module to pre-scan within the pre-scanning range.

2. The pre-scanning device according to claim 1, wherein the dynamical setting unit has at least a parameter, a plurality of pre-determined ranges, a coordinate scale or an adjustable window, the parameter is for the user to set a corresponding numeric value of the at least one parameter to define the pre-scanning range,the plurality of pre-determined ranges is for the user to select, the coordinate scale is for the user to set a corresponding coordinate of the coordinate scale to define the pre-scanning range, the adjustable window is for the user to select the pre-scanning range.

3. The pre-scanning device according to claim 1, wherein the pre-scanning range is a rectangle, and the pre-scanning range has a first side and a second side opposite to the first side, and a third side vertically connecting the first side and the second side, wherein the scanning module reciprocates along a direction parallel to the third side.

4. The pre-scanning device according to claim 3, further comprising a processing unit for determining and setting the first side or the second side to be a nearest scanning starting position to the scanning module.

5. The pre-scanning device according to claim 4, wherein the driver unit drives the scanning module to the nearest scanning starting position, such that the scanning module reciprocates along a direction parallel to the third side and pre-scans the article within the pre-scanning range.

6. The pre-scanning device according to claim 5, wherein the driver unit drives the scanning module to a scanning homing position after the pre-scanning is completed.

7. The pre-scanning device according to claim 6, wherein when the pre-scanning device receives another scan instruction during the scanning module is driving to the scanning homing position, the processing unit re-determines and sets the first side or the second side to be an another nearest scanning starting position to the scanning module, and the driver unit drives the scanning module to the another nearest scanning starting position.

8. The pre-scanning device according to claim 5, wherein the driver unit halts the scanning module at a scanning ending position after the pre-scanning is completed.

9. The pre-scanning device according to claim 8, wherein when the pre-scanning device receives a scan instruction again, the processing unit re-determines and sets the first side or the second side to be an another scanning starting position nearest to the scanning module, and the driver unit drives the scanning module to the another nearest scanning starting position.

10. A pre-scanning method for pre-scanning an article, the method comprising:
entering a dynamic setting mode;
setting a pre-scanning range; and
pre-scanning the article within the pre-scanning range.

11. The pre-scanning method according to claim 10, wherein the setting step further comprises:
providing at least a parameter; and
setting a corresponding value of the at least one parameter to define the pre-scanning range.

12. The pre-scanning method according to claim 10, wherein the setting step further comprises:
providing a plurality of pre-determined ranges; and
selecting the pre-scanning range from the pre-determined ranges.

13. The pre-scanning method according to claim 10, wherein the setting step further comprises:
providing a coordinate scale; and
setting a corresponding coordinate of the coordinate scale to define the pre-scanning range.

14. The pre-scanning method according to claim 10, wherein the setting step further comprises:
providing an adjustable window; and
selecting the pre-scanning range.

15. The pre-scanning method according to claim 10, wherein the pre-scanning range is a rectangle, the pre-scanning range has a first side and a second side opposite to the first side, and a third side vertically connecting the first side and the second side, the pre-scanning step comprises:
pre-scanning within the pre-scanning range by a scanning module along a direction parallel to the third side.

16. The pre-scanning method according to claim 15, wherein the method further comprises:
determining and setting the first side or the second side to be a scanning starting position nearest to the scanning module;
moving the scanning module to the nearest scanning starting position; and
pre-scanning the article within the pre-scanning range by the scanning module from the nearest scanning starting position along a direction parallel to the third side.

17. The pre-scanning method according to claim 15, after the step of pre-scanning, the method further comprises:
moving the scanning module to a scanning homing position.

18. The pre-scanning method according to claim 17, further comprising:
re-determining and setting the first side or the second side to be an another scanning starting position nearest to the scanning module when a scan instruction is received again during the process of moving the scanning module to the scanning homing position; and
moving the scanning module to the another nearest scanning starting position.

19. The pre-scanning method according to claim 16, after the step of pre-scanning, the method further comprises:
halting the scanning module at a scanning ending position.

20. The pre-scanning method according to claim 19, the method further comprises:
when the pre-scanning device receives a scan instruction again, the processing unit re-determines and sets the first side or the second side to be an another scanning starting position nearest to the scanning module; and
moving the scanning module to the another nearest scanning starting position.

21. The pre-scanning method according to claim 16, further comprising:
obtaining a pre-scanning image of the article; and
reversing the pre-scanning image when the pre-scanning module scans the article towards the scanning homing position.
